(19) United States
(12) Patent Application Publication
(10) Pub. No.: US 2025/0332549 A1
(43) Pub. Date: Oct. 30, 2025

(54) PERFORMANCE EVALUATION DEVICE FOR MEMBRANE FILTRATION DEVICE IN PURE WATER PRODUCTION EQUIPMENT, PURE WATER PRODUCTION SYSTEM USING THE SAME, AND PERFORMANCE EVALUATION METHOD FOR MEMBRANE FILTRATION DEVICE IN PURE WATER PRODUCTION EQUIPMENT

(71) Applicant: ORGANO CORPORATION, Tokyo (JP)

(72) Inventors: Fumitaka ICHIHARA, Tokyo (JP); Chiharu UMEZAWA, Tokyo (JP)

(73) Assignee: ORGANO CORPORATION, Tokyo (JP)

(21) Appl. No.: 18/876,706

(22) PCT Filed: May 26, 2023
(86) PCT No.: PCT/JP2023/019707

§ 371 Date: Dec. 19, 2024

(30) Foreign Application Priority Data
Jun. 30, 2022 (JP) 2022-105478

(51) Int. Cl. B01D 65/10; B01D 61/14; B01D 61/20; B01D 69/08; C02F 1/00; C02F 1/44; C02F 103/04

(52) U.S. Cl. CPC B01D 65/109; B01D 61/145; B01D 61/20; B01D 69/08; C02F 1/008; C02F 1/444; B01D 2313/903; C02F 2103/04

(57) ABSTRACT

A performance evaluation device of a membrane filtration device is a device for evaluating the performance of the membrane filtration device in pure water production equipment. The performance evaluation device includes branch lines that branch off at the inlet of the membrane filtration device from a line on which the membrane filtration device of the pure water production equipment is provided, and at least one evaluation filtration membrane device is connected to the branch lines. At least one of the evaluation filtration membrane devices has the same type of membrane as that of the membrane filtration device, and the membrane area of the membrane of at least one of the evaluation filtration membrane devices is smaller than the membrane area of the membrane of the membrane filtration device.

### TECHNICAL FIELD

This application claims the benefit of Japanese Priority Patent Application No. JP2022-105478 filed on Jun. 30, 2022, the entire contents of which are incorporated herein by reference.

The present invention relates to a performance evaluation device for a membrane filtration device in pure water production equipment, a pure water production system using the same, and a performance evaluation method for a membrane filtration device in pure water production equipment.

### BACKGROUND ART

At the end stage of an ultrapure water production device (a subsystem), a membrane filtration device such as an ultrafiltration membrane device is provided for the purpose of removing fine particles. As the requirements for ultrapure water quality become stricter, the requirements for the membrane filtration device provided at the end of the subsystem have also become stricter. Conventionally, ultrapure water was controlled for fine particles having a particle size of 50 nm or more, but in recent years, there has been a demand for controlling fine particles having a particle size of 10 nm or less.

One of the factors that increases the number of particles at the end of the subsystem is the deterioration or breakage of the membrane filtration device (more precisely, membrane modules within the membrane filtration device). Membrane filtration devices, which are originally provided to remove fine particles, can instead become a source of fine particles due to deterioration or breakage, and this deterioration and breakage can have an impact on the number of fine particles in the water outlet from the membrane filtration device. Therefore, controlling the membrane filtration device at the end of the subsystem is extremely important. JP 6,450,563 B discloses a method for diagnosing an ultrafiltration membrane according to which the number of coarse particles in the permeate or concentrated water of an ultrafiltration membrane is measured and deterioration of the ultrafiltration membrane is determined when the number exceeds a predetermined threshold. Specifically, the permeate water that has passed through the ultrafiltration membrane is sampled, fine particles in the sampled water are captured by a membrane filtration device, and the captured fine particles are observed by a scanning electron microscope (SEM).

### SUMMARY OF INVENTION

According to the diagnostic method described in JP 6,450,563 B, a sample of particles can be obtained while continuing to operate a pure water production system that includes an ultrapure water production device. However, since the evaluation of the membrane filtration device relies only on sampled water, there are limitations to the detailed evaluation of the condition of the membrane filtration device.

An object of the present invention is to provide a performance evaluation device for a membrane filtration device in pure water production equipment, this device being capable of evaluating deterioration of the performance of the membrane filtration device in more detail while minimizing the impact on the operation of the pure water production equipment.

A performance evaluation device for a membrane filtration device of the present invention is a performance evaluation device for a membrane filtration device in pure water production equipment. The performance evaluation device comprises a branch line that branches off from a line in which a membrane filtration device is provided in pure water production equipment. The branch line branches off at the inlet of the membrane filtration device, and at least one evaluation filtration membrane device is connected to the branch line. The at least one evaluation membrane filtration device has the same type of membrane as the membrane filtration device, and the membrane area of the membrane of the at least one evaluation membrane filtration device is smaller than the membrane area of the membrane of the membrane filtration device.

According to the present invention, a performance evaluation device can be provided for a membrane filtration device of pure water production equipment, and the performance evaluation device is capable of evaluating deterioration of the performance of the membrane filtration device in more detail while minimizing the impact on the operation of the pure water production equipment.

The above and other objects, features and advantages of the present application will become more apparent from the following detailed description taken in conjunction with the accompanying drawings illustrating the present application.

### BRIEF DESCRIPTION OF THE DRAWINGS

FIG. 1 is a schematic diagram of an ultrapure water production device according to one embodiment of the present invention.

FIG. 2 is a schematic diagram of a performance evaluation device of an ultrafiltration membrane device.

FIG. 3 is a schematic diagram of a test device used in the examples.

### DETAILED DESCRIPTION OF EMBODIMENTS

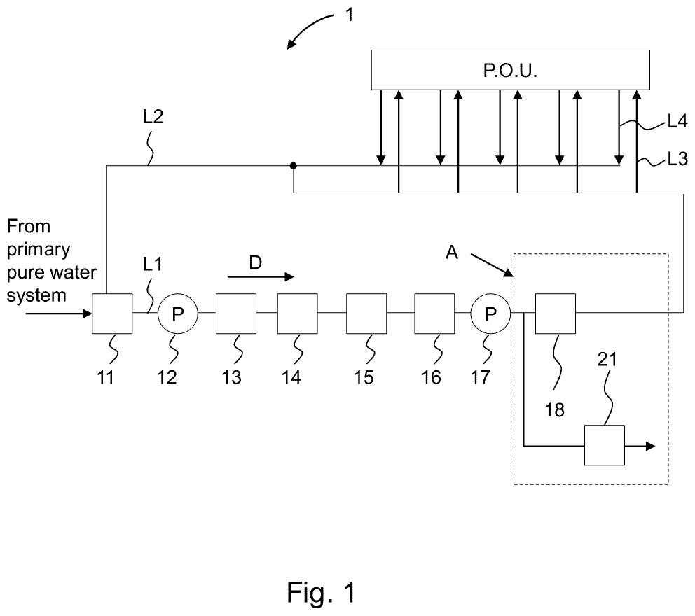

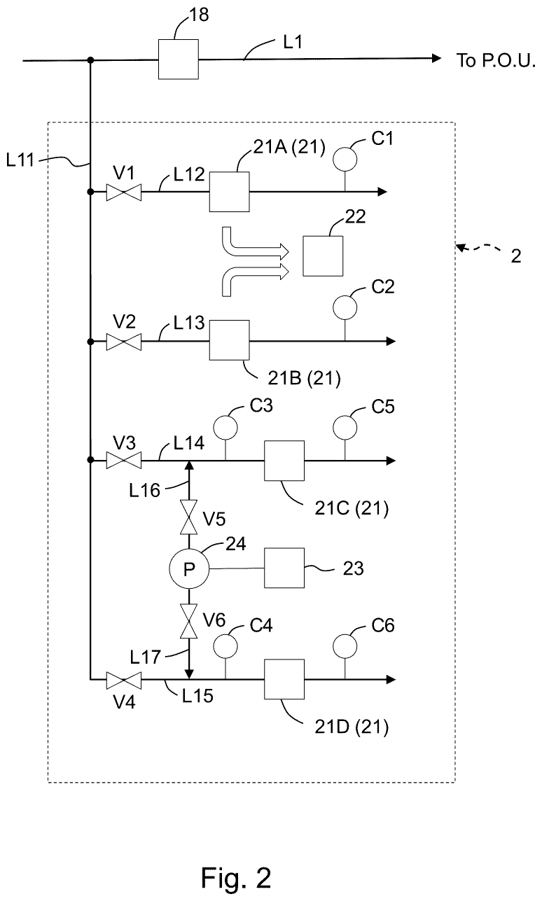

FIG. 1 shows an overview of the subsystem of ultrapure water production device 1 according to one embodiment of the present invention. FIG. 2 is an enlarged view of part A shown in FIG. 1 and shows an overview of a performance evaluation device. The subsystem is a system for producing ultrapure water to be supplied to a point of use (P.O.U.) from pure water produced in a primary pure water system (not shown) and is also referred to as a secondary pure water system. Unless otherwise specified, the subsystem is the subject in the following description of ultrapure water production device 1, and the subsystem may be referred to as ultrapure water production device 1. Ultrapure water production device 1 is used in the manufacturing process of electronic parts such as semiconductors.

The subsystem of ultrapure water production device 1 comprises main line L1 connected to the point of use (P.O.U.), a plurality of water treatment devices provided on main line L1 for producing ultrapure water, and return line L2 that returns to main line L1 ultrapure water that is not used (or, more accurately, has not been used) at the point of use (P.O.U.). On main line L1, pure water tank 11, pure water supply pump 12, heat exchanger 13, ultraviolet oxidation device 14, ion exchange device 15, membrane degassing device 16, booster pump 17, and ultrafiltration membrane device 18 are arranged in series in the order shown along the flow direction D of the pure water. Ultraviolet oxidation device 14, ion exchange device 15, membrane degassing device 16, and ultrafiltration membrane device 18 are examples of the water treatment devices mentioned above. A plurality of supply lines L3 for supplying ultrapure water to each point of use (P.O.U.) branches off from main line L1. A plurality of recovery lines L4 for recovering ultrapure water not used at each point of use (P.O.U.) merge into return line L2. Return line L2 is connected to pure water tank 11. The ultrapure water that flows from recovery lines L4 into return line L2 passes through return line L2 to pure water tank 11 and is returned to main line L1.

Pure water tank 11 stores the pure water produced in the primary pure water system. Pure water supply pump 12 supplies the pure water stored in pure water tank 11 to heat exchanger 13 in which the temperature of the pure water is adjusted. Ultraviolet oxidation device 14 irradiates the temperature-adjusted pure water with ultraviolet rays to decompose organic matter contained in the pure water. Ion exchange device 15 removes ionic components from the pure water. Ion exchange device 15 is a non-regenerative cartridge polisher in which a mixed bed of cation exchange resin and anion exchange resin is packed. Membrane degassing device 16 degasses the pure water, that is, removes dissolved oxygen and carbon dioxide contained in the pure water. Booster pump 17 is provided to pressurize the pure water when, for example, the point of use (P.O.U.) is provided at a higher location. Booster pump 17 may be omitted depending on the location of the point of use (P.O.U.). Ultrafiltration membrane device 18 finally removes fine particles contained in the pure water. Ultrafiltration membrane device 18 has a hollow fiber membrane module filled with a hollow fiber membrane. Hollow fiber membranes allow for a higher packing density in a filtration membrane module than flat or pleated membranes, and therefore an allow an increase in the amount of permeated water per one filtration membrane module. Furthermore, the hollow fiber membrane module can be easily maintained at a high level of cleanliness. The hollow fiber membrane module can be shipped, installed in ultrapure water production device 1, and replaced on-site while maintaining a high level of cleanliness. The hollow fiber membrane module may use a polysulfone membrane with a molecular weight cutoff of about 4,000 to 6,000 such as OLT-6036H manufactured by Asahi Kasei Corp. and NTU-3306-K6R manufactured by Nitto Denko (both having a molecular weight cutoff of 6,000). The molecular weight cutoff generally refers to the approximate molecular weight of a globular solute (protein) that can be retained by the membrane at 90% or more.

Ultrapure water production device 1 comprises performance evaluation device 2 that evaluates the performance (degree of deterioration) of ultrafiltration membrane device 18. Performance evaluation device 2 comprises branch lines L11 to L15 that branch off from main line L1 at the inlet of ultrafiltration membrane device 18, and at least one evaluation filtration membrane device 21 connected to branch lines L11 to L15. In this embodiment, there are two first modules (first evaluation filtration membrane devices) 21A and 21B and two second modules (second evaluation filtration membrane devices) 21C and 21D. Branch lines L11 to L15 comprise first line L11 connected to main line L1 and second to fifth lines L12 to L15 that branch off from first line L11, two first modules 21A and 21B being provided on second and third lines L12 and L13, respectively, and two second modules 21C and 21D being provided on fourth and fifth lines L14 and L15, respectively. Branch lines L11 to L15 (first line L11) are preferably provided between ultrafiltration membrane device 18 and the water treatment device closest to ultrafiltration membrane device 18 upstream of ultrafiltration membrane device 18; i.e., between membrane degassing device 16 and ultrafiltration membrane device 18 (at the inlet of the ultrafiltration membrane device 18). However, as long as the number of fine particles does not change significantly, branch lines L11 to L15 may also be provided upstream of the closest water treatment device. For example, branch lines L11 to L15 may branch off from a point between ion exchange device 15 and membrane degassing device 16, as in the embodiment. Alternatively, ion exchange device 15 may be provided between membrane degassing device 16 and ultrafiltration membrane device 18, and branch lines L11 to L15 may branch off from between ion exchange device 15 and ultrafiltration membrane device 18.

First modules 21A and 21B and second modules 21C and 21D are provided with the same type of membranes as ultrafiltration membrane device 18. The term “the same type of membranes” refers to membranes that have the same material, pore size, and dimensions (inner and outer diameters of hollow fibers, and length of hollow fibers) and that have the same filtration performance, but also includes membranes that have similar material, pore size, and dimensions and that have equivalent filtration performance. In this embodiment, first and second modules 21A to 21D and ultrafiltration membrane device 18 are evaluation filtration membrane devices in which a large number of hollow fiber membranes fill a container, and the material, pore size, and dimensions of the hollow fiber membranes are common to first and second modules 21A to 21D and ultrafiltration membrane device 18. However, the number of hollow fiber membranes in each of first and second modules 21 A to 21 D is less than the number of hollow fiber membranes in ultrafiltration membrane device 18. As a result, the membrane area of each of the hollow fiber membranes of first and second modules 21A to 21D (the membrane area of each hollow fiber membrane multiplied by the number of hollow fiber membranes) is smaller than the membrane area of the hollow fiber membranes of ultrafiltration membrane device 18. In other words, first and second modules 21A to 21D are small-sized filtration membrane devices for evaluation that simulate ultrafiltration membrane device 18. The membrane areas of the hollow fiber membranes of first and second modules 21A to 21D are the same in the case but may be different from each other.

First and second water quality meters C1 and C2 are provided at outlets of first modules 21A and 21B of second and third lines L12 and L13. First and second water quality meters C1 and C2 are fine particles counters. Instead of measuring fine particles, total organic carbon (TOC) may be measured, and the concentrations of dissolved substances such as metals and organic matter may also be measured. As will be described, since first modules 21A and 21B are provided to estimate the deterioration of ultrafiltration membrane device 18, the object of measurement is not limited as long as it is a substance that can be captured by ultrafiltration membrane device 18. Ultrafiltration membrane device 18 is basically for capturing fine particles but is also capable of capturing dissolved substances such as organic matter and metals if these substances are in a granular or colloidal form. Therefore, first and second water quality meters C1 and C2 may be any devices capable of measuring at least one of the number of particulates, TOC, and metal concentration.

First and second water quality meters C1 and C2 may each be, for example, a water quality meter that uses a spray drying method (for example, STPC3 by KANOMAX Inc.). This water quality meter comprises a spray unit, an evaporation/drying unit, and a detection unit. The spray unit samples and sprays the ultrapure water that is the object of measurement. The evaporation/drying unit removes larger droplets from the droplets produced by spraying and heats and evaporates the remaining fine droplets. Particles that were present in the ultrapure water and particles that are made up of dissolved non-volatile residues form an aerosol. In the evaporation/drying unit, the aerosol is further passed through a semi-permeable membrane to remove moisture. The detection unit classifies the precipitated aerosol by size using a differential electrostatic classifier and measures the number concentration of the classified particles using a condensation particle counter. The particle concentration in the ultrapure water is obtained by multiplying the obtained measurement value by a pre-calibrated coefficient. This method has the advantage that, in principle, it is possible to measure particles with a particle size of about 2.5 nm, which is the detection limit of a condensation particle counter, and the measurement results are not affected by the refractive index or shape of the particles.

Conventionally, a water quality meter such as a fine particles counter is provided between ultrafiltration membrane device 18 and the point of use (P.O.U.) but determining the deterioration of ultrafiltration membrane device 18 using this meter alone is problematic. Therefore, up to now, determination of the deterioration of ultrafiltration membrane device 18 has employed a direct inspection method in which the permeated water on the outlet side of ultrafiltration membrane device 18 or the concentrated water in the inlet space inside ultrafiltration membrane device 18 is sampled and observed using an SEM. However, this method requires a long time for sampling, and online measurement is difficult. First and second water quality meters C1 and C2 have a higher accuracy in detecting fine particles than the fine particle counter provided between ultrafiltration membrane device 18 and the point of use (P.O.U.), and furthermore, these water quality meters measure the number of fine particles in the outlet water of first modules 21A and 21B online, with the result that the signs and degree of deterioration of first modules 21A and 21B, and consequently, the signs and degree of deterioration of ultrafiltration membrane device 18, can be quickly comprehended. In addition, a more reliable evaluation can be made by using the water quality meters in conjunction with a water quality meter provided between ultrafiltration membrane device 18 and the point of use (P.O.U.).

Performance evaluation device 2 comprises membrane property evaluation device 22 that evaluates the film properties of first modules 21A and 21B. Membrane property evaluation device 22 measures and evaluates properties of the membrane such as the elongation retention rate and fraction retention rate of the hollow fiber. Moreover, these measurement values and evaluation results may be supplied as output. In the present invention, at least one and preferably both of the elongation retention rate and the fraction retention rate of the hollow fibers constituting the membranes of first modules 21A and 21B are measured. Membrane property evaluation device 22 is a device independent of first modules 21A and 21B. The elongation retention is determined by removing one hollow fiber membrane from first module 21A and 21B and attaching the membrane to membrane property evaluation device 22. Here, a tensile stress is applied to the membrane until it breaks to determine the tensile stress A at the time of breakage. Similarly, a new (unused) hollow fiber membrane identical to the hollow fiber membranes packed in first module 21A and 21B is attached to membrane property evaluation device 22 and tensile stress is applied until the membrane breaks to determine the tensile stress B at the time of breakage. The units of tensile stresses A and B are MPa. Membrane property evaluation device 22 calculates the elongation retention rate as A/B×100 (%). The tensile stress B may be determined in advance and stored in membrane property evaluation device 22. In this case, membrane property evaluation device 22 can calculate A/B×100 (%) based on the tensile stress A of the hollow fiber membrane that was removed from first modules 21A and 21B. Fractional retention is the removal of proteins of a given molecular weight. Fraction retention can be determined similarly. First modules 21A and 21B are attached to membrane property evaluation device 22, and the removal rate C of a protein having a predetermined molecular weight is determined. Similarly, a new (unused) evaluation filtration membrane device identical to first modules 21A and 21B is attached to membrane property evaluation device 22, and the removal rate D of a protein having a predetermined molecular weight is determined. The removal rates C and D are expressed in percentages. The predetermined molecular weight preferably roughly corresponds to the nominal molecular weight cut-off of the membrane being evaluated. For example, when evaluating a membrane with a molecular weight cutoff of 4000, a protein with a molecular weight of about 4000 is preferable used. Membrane property evaluation device 22 calculates the fraction retention rate as C/D×100 (%). The fraction retention rate D may be previously determined and stored in membrane property evaluation device 22. In this case, membrane property evaluation device 22 can calculate C/D×100 (%) based on the removal rate C of first modules 21A and 21B. When at least one of the elongation retention rate and the fraction retention rate falls below a predetermined threshold value, membrane property evaluation device 22 outputs an evaluation result indicating the evaluation result and/or a notification prompting replacement of the membranes of ultrafiltration membrane device 18. The evaluation result and notification can be output by any method, such as by outputting a signal to a control device (not shown) of ultrapure water production device 1 or by display on the screen of the control device. Based on the measurement examples to be described, the predetermined threshold values are preferably 85% or less for elongation retention and 70% or less for fraction retention.

The conventional method of estimating the state of deterioration of a membrane filtration device based on water quality does not directly diagnose whether the membrane filtration device has actually deteriorated. However, even if there is no impact on the number of particles in the permeated or concentrated water from the membrane filtration device, the possibility remains that the wafers being manufactured are being affected. The reason for this possibility is that detection accuracy tends to be low for small particles, meaning that the number of particles may actually be increasing even when no change occurs in the water quality measurement results. Since membrane property evaluation device 22 uses physical indicators to directly evaluate the state of the membrane filtration device, the state of deterioration of the membrane filtration device can be evaluated with higher reliability.

The elongation retention and fraction retention are direct indicators of membrane performance degradation, and measuring the elongation retention and fraction retention is therefore a highly reliable technique. Evaluation of elongation retention and fraction retention has consequently been carried out by membrane manufacturers in some cases, but these evaluations must be performed with ultrafiltration membrane device 18 removed from ultrapure water production device 1, and this requirement not only increases the number of work steps but also increases the possibility that foreign matter will be mixed into the ultrapure water. Moreover, once these evaluations have been carried out, the membrane cannot be reused, and as a result, these evaluations have been carried out only when some kind of malfunction occurred in ultrafiltration membrane device 18. In other words, the elongation retention rate and fraction retention rate are suitable for evaluating the performance deterioration of a membrane with high reliability but are not suitable for evaluating the performance deterioration of ultrafiltration membrane device 18 during operation. In this embodiment, the elongation retention rate and fraction retention rate are evaluated for the hollow fiber membranes of first modules 21A and 21B that simulate ultrafiltration membrane device 18, and the evaluation therefore has no impact on the operation of ultrapure water production device 1.

Fourth and fifth lines L14 and L15 are connected to the inlets of second modules 21C and 21D with addition lines L16 and L17 for adding a substance to be evaluated. Addition lines L16 and L17 are provided with evaluation water storage tank 23 for storing ultrapure water mixed with a high concentration of an evaluation substance, and pump 24 for conveying this water. First detectors C3 and C4 for detecting the evaluation substance are provided between the inlets of second modules 21C and 21D and junctions of fourth and fifth branch lines L14 and L15 with addition lines L16 and L17, respectively. Second detection devices C5 and C6 for detecting the evaluation substance are provided at the outlets of second modules 21C and 21D of fourth and fifth branch lines L14 and L15, respectively. First and second detection devices C3 to C6 are water quality meters such as fine particle counters and may be water quality meters that use the above-mentioned spray-drying method.

The particle size of the substance to be evaluated is not particularly limited, and either small particles or large fine particles can be used. Examples of evaluation substances include standard substances such as polystyrene (PSL) particles with a particle size of 123 nm and silica nanoparticles (SiO₂ particles) with a particle size of 100 nm. These substances are commercially available microparticles with a high degree of particle uniformity. Nano-sized particles (<10 nm) are preferably used as the evaluation substance to evaluate the performance deterioration of ultrafiltration membrane device 18, but the detection efficiency of small particles is generally low and detection of such particles with high precision is difficult. On the other hand, relatively large particles are highly likely to pass through a membrane when the membrane has broken or deteriorated, and consequently, even the use of large particles is quite practical. Furthermore, since first and second detectors C3 to C6 can detect large particles with high accuracy, the removal efficiency of the particles in second modules 21C and 21D can be easily calculated. The particle size of the evaluation substance can be appropriately selected taking these points into consideration. If the number of particles detected by first detection devices C3 and C4 is (particles/mL) and the number of particles detected by second detection devices C5 and C6 is N2 (particles/mL), the removal efficiency can be calculated as (N1−N2)/N1×100 (%). As described above, ultrafiltration membrane device 18 can also capture organic matter depending on the form, and an organic powder can also be used as the evaluation substance. In this case, a TOC meter may be used as first and second detection devices C3 to C6. An example of the substance to be evaluated is PEG2000 (polyethylene glycol (H(OCH₂CH₂)ₙOH) having an average molecular weight of 1850 to 2150). PEG 2000 is one of the protein molecules used to determine the molecular weight cut-off of ultrafiltration membranes.

First modules 21A and 21B that have been evaluated for elongation retention and fractional retention cannot be reused. As for second modules 21C and 21D, repeated introduction of the evaluation substance damages the membrane and reuse is therefore problematic. Therefore, a plurality of first and second modules 21A to 21D is preferably provided in parallel.

Since first and second modules 21A to 21D simulate ultrafiltration membrane device 18, the deterioration of ultrafiltration membrane device 18 is preferably evaluated with accuracy. Ideally, the deterioration of first and second modules 21A to 21D will be the same as that of ultrafiltration membrane device 18, but this uniformity may be difficult to achieve due to variations in membranes and the like. In the interest of caution, the deterioration of first and second modules 21A to 21D should be accelerated relative to the deterioration of ultrafiltration membrane device 18. Therefore, the flow rate of the ultrapure water supplied to first and second modules 21A to 21D can be made higher than the flow rate of the ultrapure water supplied to ultrafiltration membrane device 18. By increasing the flow rate, membrane degradation will progress more quickly, and this approach can thus achieve the same effect as an accelerated test. The flow rate in first and second modules 21A to 21D may be, for example, 1 to 3 times the flow rate in ultrafiltration membrane device 18. The flow rate can be adjusted, for example, by changing the ratio between the number of hollow fiber membranes in first and second modules 21A to 21D and in ultrafiltration membrane device 18, and the cross-sectional area of the container in which the hollow fiber membranes are packed. As an alternative for promoting deterioration of the membrane, a valve can be provided in first line L11 upstream of all of the branching points of second to fifth lines L12 to L15, and this valve can be repeatedly opened and closed (or degree of opening can be changed). Since pressure fluctuations are applied to first and second modules 21A to 21D, deterioration of first and second modules 21A to 21D can be accelerated compared to a case in which ultrapure water is passed through the modules at a constant flow rate.

The flow rate of the ultrapure water supplied to the plurality of first modules 21A and 21B can be varied for each of first modules 21A and 21B. For example, the flow rate in first module 21A can be higher than the flow rate in second module 21B. Since the measurement values of first and second water quality meters C1 and C2 can be expected to deteriorate in order starting with the evaluation filtration membrane device having the highest flow rate (in this case, first module 21A), the time of deterioration of ultrafiltration membrane device 18 becomes easier to predict. The flow rate of ultrapure water supplied to second modules 21C and 21D may also be varied for each of second modules 21C and 21D. For example, the flow rate of the ultrapure water supplied to second module 21C can be made higher than the flow rate of the ultrapure water supplied to second module 21D. Since the removal efficiency of fine particles can be expected to decrease in order from the evaluation filtration membrane device having the highest flow rate (in this case, second module 21C), the time of deterioration of ultrafiltration membrane device 18 is easier to predict. As a result, the operation and management of ultrafiltration membrane device 18 is facilitated.

The evaluation of the performance of ultrafiltration membrane device 18 of ultrapure water production device 1 is carried out according to the procedure next described. Inlet water of ultrafiltration membrane device 18 is supplied from main line L1 of ultrapure water production device 1 to first and second modules 21A to 21D connected to branch lines L11 to L15. The inlet water of ultrafiltration membrane device 18 is continuously supplied to first and second modules 21A to 21D during operation of the ultrapure water production device. The quality of the water at the outlet of first module 21A or 21B is continuously measured online using first or second water quality meter C1 and C2. However, both first and second water quality meters C1 and C2 can also be used to measure the quality of the water at the outlets of first modules 21A and 21B, respectively. The elongation retention rate and fraction retention rate are evaluated at appropriate times. Although no particular limitation applies to the timing, the evaluation may take place when the total flow rate reaches a predetermined value or when either first or second water quality meter C1 and C2 indicates an abnormal value. When evaluating the elongation retention rate and fraction retention rate, first module 21A or 21B that is to be evaluated is first isolated by inlet valve V1 or V2, first module 21A and 21B that is to be evaluated is removed from second or third line L12 or L13 and attached to membrane property evaluation device 22, and the test is performed. Inlet valve V1 or V2 remains closed until replacement of ultrafiltration membrane device 18 is performed. Alternatively, another module may be provided in second or third line L12 or L13 from which first modules 21A and 21B were removed.

The substance to be evaluated is added to one of second modules 21C and 21D (in this case, second module 21C). When adding the substance to be evaluated, valve V5 of addition line L16 connected to second module 21C to be evaluated is opened, and valve V6 of addition line L17 connected to second module 21D that is not to be evaluated is closed. The substance to be evaluated is added at a predetermined timing. Before adding the substance to be evaluated, first and second detection devices C3 and C5 corresponding to second module 21C to be evaluated are started, and first and second detection devices C3 and C5 detect the number of particles and the like. The removal efficiency can be determined from the measurement results of first and second detectors C3 and C5 as described above. Since second module 21C gradually deteriorates due to the addition of the substance being evaluated, second module 21C is preferably not used after a predetermined number of additions, and the substance to be evaluated is preferably subsequently added to the other second module 21D.

Any one of first modules 21A and 21B and second modules 21C and 21D may be omitted, in which case the above evaluation is performed using only any one of first modules 21A and 21B and second modules 21C and 21D. That is, in this embodiment, the performance of ultrafiltration membrane device 18 is evaluated by measuring at least one of the physical properties of at least one evaluation filtration membrane device 21 and the water quality of the treated water of at least one evaluation filtration membrane device 21.

The elongation retention rate and the fraction retention rate were measured (measurement examples) using two hollow fiber membrane modules (first and second hollow fiber membrane modules 31 and 32). As hollow fiber membrane modules 31 and 32, ultrafiltration membrane modules 21XSLP-1036 (manufactured by Asahi Kasei Corp.) having a membrane area of 0.29 m² were used. First hollow fiber membrane module 31 used a new hollow fiber membrane, and second hollow fiber membrane module 32 used a new hollow fiber membrane that had been immersed in a 1% H₂O₂ solution at room temperature for 7 to 14 days. That is, second hollow fiber membrane module 32 simulates a deteriorated hollow fiber membrane module. In second hollow fiber membrane module 32, the elongation retention rate was 87% and the fraction retention rate was 71%. This confirmed that the elongation retention rate and fraction retention rate of the deteriorated hollow fiber membrane module decreased.

### Example 1

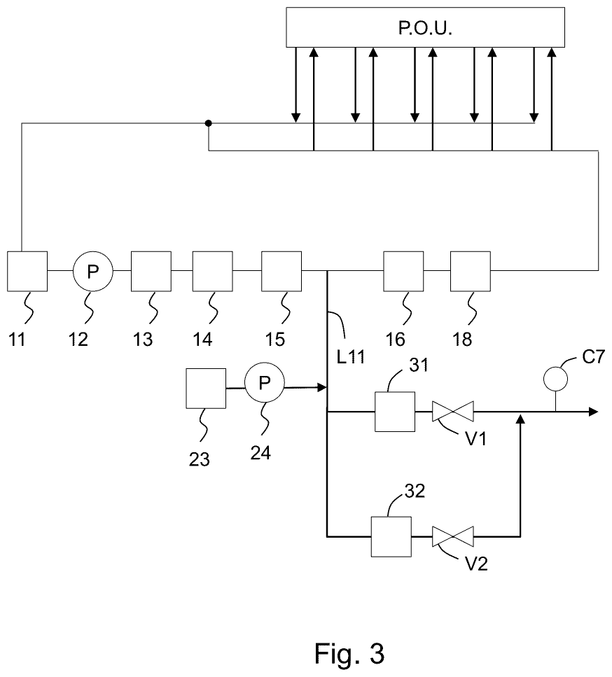

Next, a test was carried out using the test device shown in FIG. 3. The test device corresponds to ultrapure water production device 1 shown in FIG. 1. Equivalent elements are given the same reference numerals and redundant explanations are omitted. First hollow fiber membrane module 31 and second hollow fiber membrane module 32 prepared in the same manner as in the above measurement example were arranged in parallel. In the interest of convenience, branch line L11 was provided between ion exchange device 15 and membrane degassing device 16 rather than between membrane degassing device 16 and ultrafiltration membrane device 18, but this difference in the branch position is believed to have little effect.

First, a portion of the ultrapure water flowing through the subsystem was supplied from branch line L11 to first hollow fiber membrane module 31, and the number of particles was measured by particle counter C7. Next, a valve (not shown) was switched to supply a portion of the ultrapure water flowing through the subsystem to second hollow fiber membrane module 32, and the number of particles was measured by particle counter C7. As particle counter C7, an STPC3 manufactured by KANOMAX Inc. was used. This particle counter can detect not only particles, but also dissolved components such as organic matter and metals. Three particle size categories were used: 3 nm, 9 nm, and 15 nm, by which fine particles were detected having measurement ranges of 3 nm or more, 9 nm or more, and 15 nm or more, respectively. The flow rate of the ultrapure water flowing through first and second hollow fiber membrane modules 31 and 32 was 1.5 L/min, the flow velocity was 0.31 (m/h), and the pressure difference between first hollow fiber membrane module 31 and second hollow fiber membrane module 32 was 0.09 (MPa) and 0.07 (MPa), respectively.

The results are shown in Table 1. In the table, first hollow fiber membrane module 31 is indicated as UF#1, and second hollow fiber membrane module 32 is indicated as UF#2. Although there were differences depending on the measurement range, in the measurement range of 9 nm or more, the measured particle number of the outlet water of UF#2 was 11% greater than the measured particle number of the outlet water of UF#1. This confirmed that the deterioration in performance of ultrafiltration membrane device 18 can be estimated by using first and second water quality meters C1 and C2 to measure the number of particles in the outlet water of first modules 21A and 21B. Furthermore, since the pressure difference in second hollow fiber membrane module 32 is smaller than the pressure difference in first hollow fiber membrane module 31, it is considered that the deterioration in performance of ultrafiltration membrane device 18 can also be estimated by comparing the pressure difference between first modules 21A and 21B with the pressure difference in ultrafiltration membrane device 18.

TABLE 1

| | | | Increase or | Measuring |
|---|---|---|---|---|
| Number of fine particles | | | decrease of UF#2 | instrument |
| (×10⁶ particles/mL) | | | relative to UF#1 | (Measurement |
| Supply | UF#1 | UF#2 | (B − A)/ | range is in |
| water | (A) | (B) | A*100 (%) | parentheses) |
| 5.3 | 15 | 14 | −6 | STPC (≥3 nm) |
| 2.8 | 3.4 | 3.8 | +11 | STPC (≥9 nm) |
| 1.1 | 1.2 | 1.2 | ±0 | STPC (≥15 nm) |

### Example 2

Next, a portion of the ultrapure water flowing through the subsystem was supplied from branch line L11 to first hollow fiber membrane module 31 as in Example 1 while a standard substance was added to the supply water to determine the removal efficiency of the standard substance in first hollow fiber membrane module 31. Next, a valve (not shown) was switched to supply a portion of the ultrapure water flowing through the subsystem to second hollow fiber membrane module 32 while adding a standard substance to the supply water to determine the removal efficiency of the standard substance in second hollow fiber membrane module 32. As standard substances, PEG2000, PSL particles with a particle size of 123 nm and SiO₂ particles with a particle size of 100 nm were used. When PEG2000 was used, the STPC3 manufactured by KANOMAX Inc. was used as particle counter C7. When PSL particles were used, a liquid particle counter KL-30A (minimum measurable particle size 50 nm) manufactured by Rion Co., Ltd. was used as particle counter C7. When SiO₂ particles were used, a liquid particle counter KL-27 (minimum measurable particle size 100 nm) manufactured by Rion Co., Ltd. was used as particle counter C7. The flow rate, flow velocity, and differential pressure of the ultrapure water flowing through first and second hollow fiber membrane modules 31 and 32 were the same as those in Example 1.

The results are shown in Table 2. In the table, first hollow fiber membrane module 31 is indicated as UF#1, and second hollow fiber membrane module 32 is indicated as UF#2. When PSL particles and SiO₂ particles were used, no significant difference in removal efficiency was observed between UF#1 and UF#2, but when PEG2000 was used, a significant difference was observed. This result confirmed that the performance deterioration of ultrafiltration membrane device 18 can be estimated by measuring the removal efficiencies of second modules 21C and 21D using first and second detection devices C3 to C6.

TABLE 2

| | | | Increase or | Measuring |
|---|---|---|---|---|
| | | | decrease of UF#2 | instrument |
| | Removal efficiency (%) | | relative to UF#1 | (Measurement |
| Standard | UF#1 | UF#2 | (B − A)/ | range is in |
| substance | (A) | (B) | A*100 (%) | parentheses) |
| PEG2000 | 42 | 15 | −64 | STPC (≥3 nm) |
| | 36 | 27 | −25 | STPC (≥9 nm) |
| | 34 | 33 | ±0 | STPC |
| | | | | (≥15 nm) |
| 100 nm- | 99 | 100 | +1 | KL-30A |
| SiO₂ | | | | (≥50 nm) |
| (500/mL) | | | | |
| 123 nm- | 100 | 100 | ±0 | |
| PSL | | | | |
| (500/mL) | | | | |
| 123 nm- | 100 | 100 | ±0 | KL-27 |
| PSL | | | | (≥100 nm) |
| (500/mL) | | | | |

Although the present invention has been described above with reference to embodiments and examples, the present invention is not limited to these embodiments and examples. For example, the filtration membrane device to be evaluated may be a microfiltration membrane or may be a flat membrane or a pleated membrane. The number of first modules and second modules is not limited to two, and more first modules and second modules may be provided. Providing a plurality of each of the first and second modules allows evaluations to be carried out by changing the evaluation period and evaluation conditions (water flow conditions such as linear velocity) of the first and second modules. Conversely, the elongation retention rate and fractional retention rate can be evaluated even if only one first module and one second module are provided. Hollow fiber membranes that are made of the same material and that have the same pore size but that are shorter in length than ultrafiltration membrane device 18 can be used to reduce the size of the first and second modules. Furthermore, although the embodiment and examples are directed to an ultrapure water production device, the present invention can be suitably applied to all pure water production equipment including the ultrapure water production device.

While several preferred embodiments of the invention have been shown and described in detail, it will be understood that various changes and modifications can be made without departing from the spirit or scope of the appended claims.

### List of Reference Signs

1 ultrapure water production device
2 performance evaluation device
18 ultrafiltration membrane device
21A, 21B first module
21C, 21D second module
C1, C2 first and second water quality meters
C3 to C6 first to fourth detection devices
L1 main line
L11 to L15 branch lines
L16, L17 addition lines

1. A performance evaluation device for a membrane filtration device provided in pure water production equipment, comprising:
a branch line that branches off from a line on which the membrane filtration device is provided in the pure water production equipment, at an inlet of the membrane filtration device; and
at least one evaluation filtration membrane device connected to the branch line, wherein
the at least one evaluation filtration membrane device has the same type of membrane as the membrane filtration device, and
the membrane area of the membrane of the at least one evaluation filtration membrane device is smaller than the membrane area of the membrane of the membrane filtration device.

2. The performance evaluation device according to claim 1, wherein the at least one evaluation filtration membrane device comprises a first module,
the performance evaluation device further comprising a membrane property evaluation device for evaluating a film property of the first module,
wherein the membrane property evaluation device measures at least one of an elongation retention rate of a fiber constituting the membrane of the first module and a fraction retention rate of the first module.

3. The performance evaluation device according to claim 2, wherein the membrane property evaluation device outputs a notification prompting replacement of the membrane of the membrane filtration device when the elongation retention rate becomes 85% or less or the fraction retention rate becomes 70% or less.

4. The performance evaluation device according to claim 2, further comprising a water quality meter provided at an outlet of the first module of the branch line.

5. The performance evaluation device according to claim 1, wherein the at least one evaluation filtration membrane device comprises a second module,
the performance evaluation device further comprising:
an addition line that is connected to an inlet of the second module on the branch line and that adds a substance to be evaluated; and
a detection device that is provided at an outlet of the second module of the branch line and that detects the substance to be evaluated.

6. The performance evaluation device according to claim 1, wherein the at least one evaluation filtration membrane device comprises a plurality of first modules provided in parallel and a plurality of second modules provided in parallel.

7. The performance evaluation device according to claim 6, wherein flow rates of the water supplied to the plurality of first modules are different from one another, and flow rates of the water supplied to the plurality of second modules are different from one another.

8. The performance evaluation device according to claim 1, wherein a flow rate of water supplied to the at least one evaluation filtration membrane device is higher than a flow rate of water supplied to the membrane filtration device of the pure water production equipment.

9. A performance evaluation method for a membrane filtration device provided in pure water production equipment, comprising:
supplying inlet water of the membrane filtration device to at least one evaluation filtration membrane device connected to a branch line branching at an inlet of the membrane filtration device from a line on which the membrane filtration device of the pure water production equipment is provided; and
evaluating the performance of the membrane filtration device by measuring at least one of the physical properties of the at least one evaluation filtration membrane device and the water quality of the treated water of the at least one evaluation filtration membrane device, wherein:
the at least one evaluation filtration membrane device has the same type of membrane as the membrane filtration device; and
the membrane area of the membrane of the at least one evaluation filtration membrane device is smaller than the membrane area of the membrane of the membrane filtration device.

10. A pure water production system comprising:
a membrane filtration device;
a line on which the membrane filtration device is provided; and
the performance evaluation device according to claim 1.
